(19) United States
(12) Patent Application Publication
(10) Pub. No.: US 2006/0169088 A1
(43) Pub. Date: Aug. 3, 2006

(54) Raking gage cluster mount

(76) Inventors: Randy W. Jones, North Branch, MI (US); Lee M. Tinnin, Clio, MI (US); Ronald H. Dybalski, Oxford, MI (US); Jason R. Ridgway, Bay City, MI (US); Bruce M. Collier, Saginaw, MI (US); Frederick J. Berg, Auburn, MI (US); William D. Cymbal, Freeland, MI (US)

Correspondence Address: DELPHI TECHNOLOGIES, INC., M/C 480-410-202, PO BOX 5052, TROY, MI, 48007, US

(21) Appl. No.: 11/047,894

(22) Filed: Feb. 1, 2005

(51) Int. Cl. B62D 1/18

(52) U.S. Cl. 74/493; 280/775

(57) ABSTRACT

The invention provides a steering column assembly for supporting a steering wheel in a vehicle. The steering column assembly includes a steering column having a first end and a longitudinal axis. The steering column assembly is disposable in the vehicle for raking movement about the first end and for collapsing movement along the longitudinal axis. The steering column assembly also includes a collar engaged with the steering column to move with the steering column at least during the raking movement. The steering column assembly also includes a support bracket for supporting at least one gage of the vehicle. The support bracket is releasibly engaged with the collar such that the support bracket separates from the collar in response to the collapsing movement.

### FIELD OF THE INVENTION

The invention relates to a steering column for a vehicle and more particularly to steering column operable to support a gage cluster.

### BACKGROUND OF THE INVENTION

A steering column usually extends into the vehicle passenger compartment under the instrument panel. One or more gages are mounted, or clustered, on the instrument panel. In the past, gages which are not included on the instrument panel have been fixedly mounted to the steering column structure. Examples of these arrangements are shown in U.S. Pat. Nos. 1,795,566; 1,944,905; 2,465,825; and 4,368,454.

### SUMMARY OF THE INVENTION AND ADVANTAGES

The invention provides a steering column assembly for supporting a steering wheel in a vehicle. The steering column assembly includes a steering column having a first end and a longitudinal axis. The steering column assembly is disposable in the vehicle for raking movement about the first end and for collapsing movement along the longitudinal axis. The steering column assembly also includes a collar engaged with the steering column to move with the steering column at least during the raking movement. The steering column assembly also includes a support bracket for supporting at least one gage of the vehicle. The support bracket is releasibly engaged with the collar such that the support bracket separates from the collar in response to the collapsing movement.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a first perspective view of a first exemplary embodiment of the invention;

FIG. 2 is a second perspective view of the first exemplary embodiment of the invention;

FIG. 3 is a third perspective view of the first exemplary embodiment of the invention;

FIG. 4 is a perspective view of a second exemplary embodiment of the invention;

FIG. 5 is a first perspective view of a third exemplary embodiment of the invention; and

FIG. 6 is a second perspective view of the third exemplary embodiment of the invention.

### DETAILED DESCRIPTION OF THE PREFERRED EMBODIMENT

A plurality of different embodiments of the invention are shown in the Figures of the application. Similar features are shown in the various embodiments of the invention. Similar features have been numbered with a common reference numeral and have been differentiated by an alphabetic designation. Similar features are structured similarly, operate similarly, and/or have the same function unless otherwise indicated by the drawings or this specification. Furthermore, particular features of one embodiment can replace corresponding features in another embodiment unless otherwise indicated by the drawings or this specification.

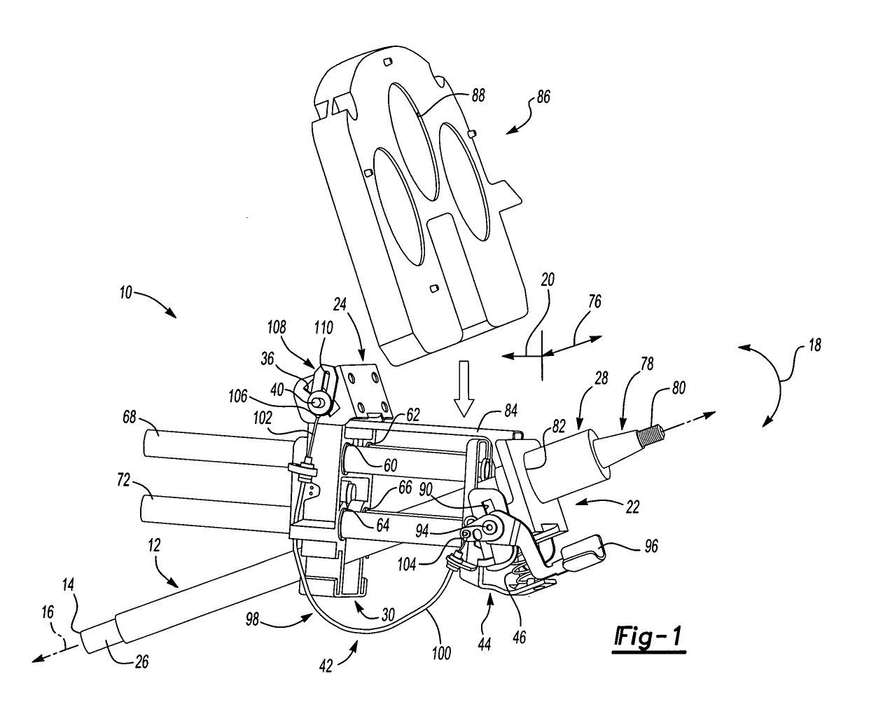

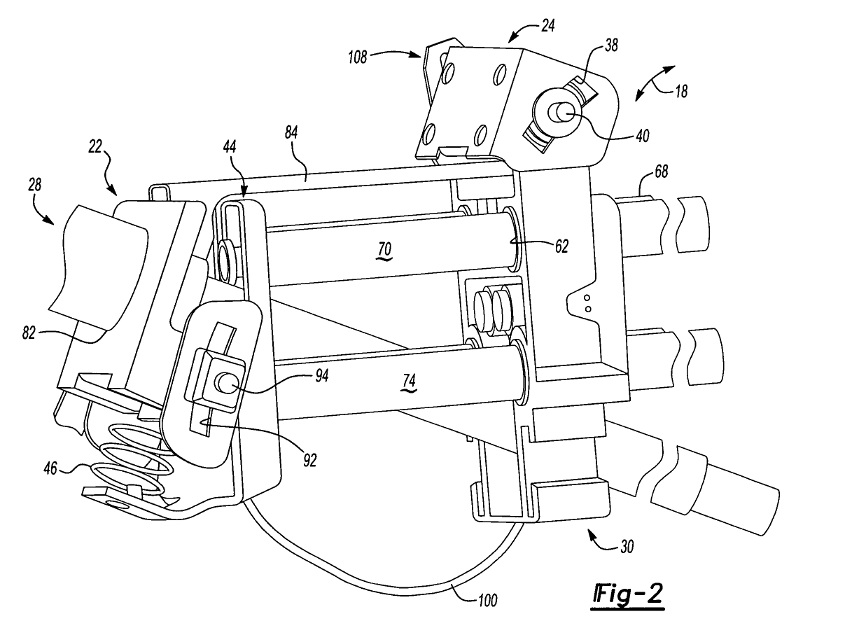

Referring now to FIGS. 1-3, in a first exemplary embodiment of the invention, a steering column assembly 10 for supporting a steering wheel in a vehicle includes a steering column 12 having a first end 14 and a longitudinal axis 16. The steering column assembly 10 is disposable in the vehicle for raking movement 18 about the first end 14 and for collapsing movement 20 at least partially along the longitudinal axis 16. The steering column assembly 10 also includes a collar 22 engaged with the steering column 12 to move with the steering column 12 at least during the raking movement 18. The steering column assembly 10 also includes a support bracket 24 for supporting at least one gage of the vehicle. The support bracket 24 is releasibly engaged with the collar 22 such that the support bracket 24 separates from the collar 22 in response to the collapsing movement 20.

In the first exemplary embodiment, the steering column 12 includes a first steering column member 26 and a second steering column member 28. The first steering column member 26 defines the first end 14. In alternative embodiments of the invention, the second steering column member 28 could be disposed for the telescoping movement 76 relative to the first steering column member 26 along the longitudinal axis 16. The arrow 76 shown in FIG. 1 is for illustrative purposes to show the general direction of telescoping movement. It is noted that the exemplary embodiments of the invention shown in the application are not telescopically adjustable, although alternative embodiments of the invention could be telescopically adjustable. The second steering column member 28 is disposed for raking movement 18 with the first steering column member 26. The first and second steering column members 26, 28 encircle a steering shaft 78 defining a steering wheel supporting end 80. The steering wheel supporting end 80 engages a steering wheel (not shown). At least the second steering column member 28 is movable along the longitudinal axis 16 during collapsing movement 20.

The collar 22 encircles the second steering column member 28 to move with the second steering column member 28 during raking movement 18. In alternative embodiments of the invention, the collar 22 could be slidable relative to the second steering column member 28 to accommodate telescoping movement 76. The second steering column member 28 engages the collar along a collar aperture 82. The first exemplary embodiment includes an extension bracket 84 operably disposed between the collar 22 and the support bracket 24. The extension bracket 84 can be integral with the collar 22 or can be fixedly connected to the collar 22. In alternative embodiments of the invention, the extension bracket 84 could be releasibly engaged with the collar 22 and fixedly connected to the support bracket 24. When the steering column 12 moves in raking movement 18, the collar 22, extension bracket 84, and support bracket 24 move in raking movement as well.

The support bracket 24 can be fixedly engaged with an gage cluster support 86. The support 86 includes one or more apertures, such as aperture 88. Each aperture can receive a gage associated with a monitored condition of the vehicle. In the first exemplary embodiment of the invention, the gages (not shown) can be fixedly mounted to the support 86 and the support 86 can be fixedly mounted to the support bracket 24. As a result, when the steering column 12 moves in raking movement 18, the support 86 and gages move in raking movement as well.

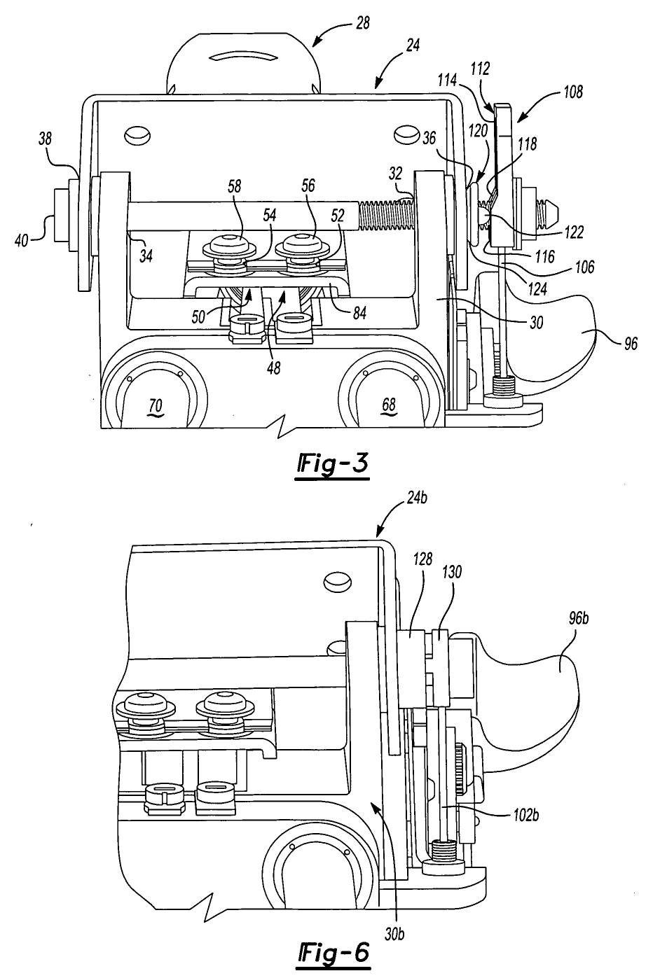

The first exemplary embodiment of the invention also includes a mounting bracket 30 operable to be fixedly mounted to the vehicle. The support bracket 24 is slidably engaged with the mounting bracket 30. For example, as best shown in FIG. 3, the mounting bracket 30 includes first and second apertures 32, 34 and the support bracket 24 includes first and second arcuate slots 36, 38. The first and second arcuate slots 36, 38 are radially centered on the first end 14 of the first steering column member 26. In other words, the first and second arcuate slots 36, 38 correspond to the path of raking movement 18. A pin 40 extends through the first and second apertures 32, 34 and the first and second arcuate slots 36, 38. When the steering column 12 and support bracket 24 are not being moved in raking movement 18, a weight of the support bracket 24, as well as a weight of the support 86 and any gages, can be supported on the pin 40 via the slots 36, 38.

The first exemplary embodiment of the invention also includes a rake bracket 44 slidably engaged with the collar 22. The rake bracket 44 includes slots 90, 92 and the collar 22 includes apertures (not visible) adjacent the slots 90, 92. A bolt 94 extends through the slots 90, 92 and the apertures (not visible) of the collar 22. The slots 90, 92 are centered on the first end 14, corresponding to the raking movement 18. The bolt 94 travels the lengths of the slots 90, 92 as the collar 22 moves in raking movement 18 with the steering column 12. A spring 46 can be disposed between the rake bracket 44 and the collar 22 to urge the collar 22 upwardly.

The first exemplary embodiment of the invention also includes a lock 42 operably disposed to concurrently lock the mounting bracket 30 and support bracket 24 relative to one another as well as lock the rake bracket 44 and the collar 22 relative to one another. The lock 42 includes a lever 96 and a cable assembly 98. The lever 96 pivots about an axis defined by the bolt 94. The lever 96 is associated with a pair of cams (not visible) that move apart from one another in response to rotation of the lever 96 in a first direction to lock the rake bracket 44 and the collar 22 relative to one another. The pair of cams (not visible) move closer together in response to rotation of the lever 96 in a second direction opposite the first direction to unlock the rake bracket 44 and the collar 22 relative to one another.

The cable assembly 98 includes a sheath 100 and a cable 102 slidably movable in the sheath 100. The sheath 100 is fixed to the collar 22 and the mounting bracket 30. A first end 104 of the cable 102 is engaged with one end of the lever 96 to move with the lever 96. A second end 106 of the cable 102 is engaged with a plate 108. The plate 108 includes a slot 110 and the pin 40 extends through the slot 110. The plate 108 also includes a cam surface 112 having a first portion 114, a second portion 116, and a transition portion 118. The lock 42 also includes a locking member 120 having a cam follower portion 122 and moveable between locked and unlocked positions. The cam surface 112 engages the cam follower portion 122 to move the locking member 120 between the locked and unlocked positions.

When the lever 96 is rotated in the first direction as set forth above (locking the rake bracket 44 and the collar 22 relative to one another), the plate 108 moves to the position shown in FIGS. 1-3 to lock the support bracket 24 relative to the mounting bracket 30. The cam surface 112 cooperates with the cam follower 122 to urge the locking member 120 into the slot 36. The locking member 120 includes a tapered surface 124 projecting into the slot 36 such that a locking force between the support bracket 24 and the mounting bracket 30 increases as the locking member 120 is urged further into the slot 36. The locking member 120 takes up the clearance between the pin 40 and the slot 36.

When the lever 96 is rotated in the second direction as set forth above (unlocking the rake bracket 44 and the collar 22 relative to one another), the plate 108 moves downwardly from the position shown in FIGS. 1-3 to unlock the support bracket 24 relative to the mounting bracket 30. The cable 102 pulls the plate 108 and the plate 108 is guided in movement by the cooperation between the slot 110 and the pin 40. The cam follower portion 122 slides along the cam surface 112 from the second portion 116, along the transition portion 118, to the first portion 114. The locking member 120 moves and a clearance is defined between the pin 40 and the slot 36.

In the first exemplary embodiment of the invention, the extension bracket 84 of the collar 22 includes connecting apertures 48, 50 and the support bracket 24 includes slots 52, 54 aligned with the connecting apertures 48, 50. Each of the slots 52, 54 includes a closed end as well as an open end spaced further from the collar 22 relative to the closed end. The open ends of the slots 52, 54 are shown in FIG. 3. Bolts 56, 58 extend through the connecting apertures 48, 50 and the slots 52, 54 to releasibly engage the support bracket and the collar 22 relative to one another. When the steering column assembly 10 is operating under normal vehicle conditions, the support bracket 24 and collar 22 are fixed relative to one another, being moveable together in raking movement 18.

In response to an impact situation, the steering column 12 moves in collapsing movement 20 along the longitudinal axis 16. During at least a portion of the collapsing movement, the collar 22 moves with the steering column 12 in collapsing movement. When the collar 22 moves in collapsing movement 20, the bolts 56, 58 move out of the slots 52, 54, releasing the support bracket 24 from the collar 22. The collar 22 can continue to move in collapsing movement 20 with the steering column 12 while the support bracket 24 remains substantially fixed relative to the vehicle.

In the first exemplary embodiment of the invention, the rake bracket 44 and the mounting bracket 30 are slidably engaged with one another. The mounting bracket 30 includes guide apertures 60, 62, 64, 66. Elongate members 68, 70, 72, 74 fixedly engaged with the rake bracket 44 and are slidably received in the guide apertures 60, 62, 64, 66. The cooperation between the guide apertures 60, 62, 64, 66 and the elongate members 68, 70, 72, 74 guide movement of the rake bracket 44 relative to the mounting bracket 30 during the collapsing movement 20.

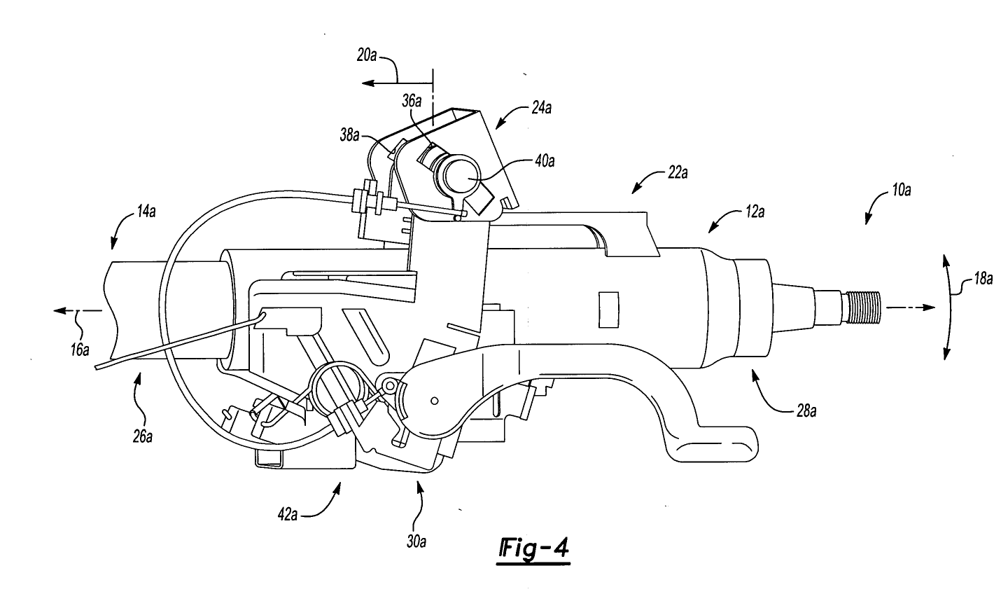

Referring now to FIG. 4, in a second exemplary embodiment of the invention, a steering column assembly 10a for supporting a steering wheel in a vehicle includes a steering column 12a having a first end 14a and a longitudinal axis 16a. The steering column assembly 10a is disposable in the vehicle for raking movement 18a about the first end 14a and for collapsing movement 20a along the longitudinal axis 16a. The steering column assembly 10a also includes a collar 22a engaged with the steering column 12a to move with the steering column 12a at least during the raking movement 18a. The steering column assembly 10a also includes a support bracket 24a for supporting at least one gage of the vehicle. The support bracket 24a is releasibly engaged with the collar 22a such that the support bracket 24a separates from the collar 22a in response to the collapsing movement 20a.

In the second exemplary embodiment, the steering column 12a includes a first steering column member 26a and a second steering column member 28a. Both the first and second steering column members 26a, 28a are movable during collapsing movement 20a. The steering column member 26a is not disposed for telescoping movement relative to the second steering column member 28a. A mounting bracket 30a is operable to be fixedly mounted to the vehicle and the support bracket 24a is slidably engaged with the mounting bracket 30a. The support bracket 24a includes first and second arcuate slots 36a, 38a radially centered on the first end 14a of the first steering column member 26a. A pin 40a extending through apertures of the mounting bracket 30a and the first and second arcuate slots 36a, 38a. A lock 42a is operably disposed to selectively lock the mounting bracket 30a and support bracket 24a relative to one another as well as lock the mounting bracket 30a relative to the steering column 12a.

In the second exemplary embodiment of the invention, the collar 22a could be received in slots defined in the second steering column member 28a to permit telescoping adjustment of the second steering column member 28a relative to the first steering column member 26a. The slots would define a length such that an end of the slot may engage the collar 22a during collapsing movement 20a and cause the collar 20a to move along the longitudinal axis 16a. The collar 22a is releasibly connected to the support bracket 24a similar to the connection between the collar 22 and support bracket 24 described above.

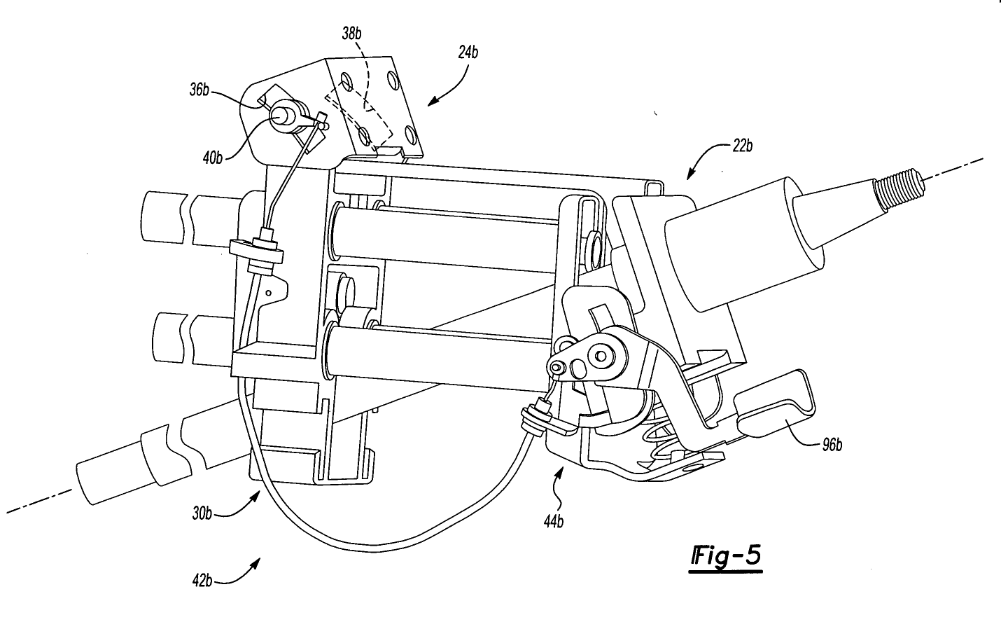

Referring now to FIG. 5-6, in a third exemplary embodiment of the invention, a mounting bracket 30b is operable to be fixedly mounted to the vehicle and the support bracket 24b is slidably engaged with the mounting bracket 30b. The support bracket 24b includes first and second arcuate slots 36b, 38b radially centered on the first end of the first steering column member. A pin 40b extending through apertures of the mounting bracket 30b and the first and second arcuate slots 36b, 38b. A lock 42b is operably disposed to selectively lock the mounting bracket 30b and support bracket 24b relative to one another. The lock 42b also locks a collar 22b and a rake bracket 44b relative to one another. The lock 42b includes cams 128, 130. The cam 130 is engaged with a cable 102b to be rotated in response to rotation of a lever 96b. The cams 128, 130 move further apart in response to rotation of the cam 130 in a first direction to lock the support bracket 24b and the mounting bracket 30b relative to one another. The cams 128, 130 move closer together in response to rotation of the cam 128 in a second direction opposite the first direction to unlock the support bracket 24b and the mounting bracket 30b relative to one another.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A steering column assembly for supporting a steering wheel in a vehicle comprising:
a steering column having a first end and a longitudinal axis and being disposable in a vehicle for raking movement about said first end and collapsing movement at least partially along said longitudinal axis;
a collar engaged with said steering column to move with said steering column at least during said raking movement; and
a support bracket for supporting at least one gage of the vehicle and releasibly engaged with said collar such that said support bracket separates from said collar in response to said collapsing movement.

2. The steering column assembly of claim 1 wherein said collar is further defined as being slidable relative to said steering column.

3. The steering column assembly of claim 2 wherein at least a portion of said steering column is movable along said longitudinal axis in telescoping movement.

4. The steering column assembly of claim 3 wherein said collar substantially encircles said portion of said steering column.

5. The steering column assembly of claim 4 wherein said steering column further comprises:
a first steering column member defining said first end; and
a second steering column member disposed for said telescoping movement relative to said first steering column member along said longitudinal axis and for said raking movement with said first steering column member, wherein said collar encircles said second steering column member and is slidable relative to said second steering column member during said telescoping movement.

6. The steering column assembly of claim 5 wherein at least said second steering column member is moveable in said collapsing movement along said longitudinal axis.

7. The steering column assembly of claim 1 further comprising:
a mounting bracket operable to be fixedly mounted to the vehicle wherein said support bracket is slidably engaged with said mounting bracket.

8. The steering column assembly of claim 7 wherein said mounting bracket includes first and second apertures and said support bracket includes first and second arcuate slots radially centered on said first end of said first steering column member and wherein said steering column assembly further comprises a pin extending through said first and second apertures and said first and second arcuate slots.

9. The steering column assembly of claim 8 further comprising:
a lock operably disposed to selectively lock said mounting bracket and support bracket relative to one another.

10. The steering column assembly of claim 9 further comprising:
a rake bracket slidably engaged with said collar.

11. The steering column assembly of claim 10 wherein said lock is further defined as being operably disposed to concurrently selectively lock said mounting bracket and support bracket relative to one another and selectively lock said rake bracket and said collar relative to one another.

12. The steering column assembly of claim 10 further comprising:
a spring disposed between said rake bracket and said collar to urge said collar upwardly.

13. The steering column assembly of claim 10 wherein said rake bracket and said mounting bracket are further defined as being slidably engaged with one another.

14. The steering column assembly of claim 1 wherein:
said collar further comprises at least one connecting aperture;
said support bracket further comprises at least one slot aligned with said at least one connecting aperture and having a closed end and an open end spaced further from said collar relative to said closed end; and
said steering column assembly further comprises at least one bolt extending through said at least one connecting aperture and said at least one slot.

15. A method for supporting a steering wheel in a vehicle comprising the steps of:
disposing a steering column having a first end and a longitudinal axis in a vehicle for raking movement about the first end and for collapsing movement along said longitudinal axis;
engaging a collar with the steering column to move with the steering column at least during the raking movement; and
releasibly engaging a support bracket for supporting at least one gage of the vehicle with the collar such that said support bracket separates from said collar in response to the collapsing movement.

16. The method of claim 15 further comprising the steps of:
moving the steering column about the first end in the raking movement;
maintaining the engagement between the support bracket and the collar during said moving step;
collapsing the steering column assembly along the longitudinal axis; and
disengaging the support bracket and the collar with respect to one another in response to said collapsing step.

17. The method of claim 16 further comprising the steps of:
telescopically adjusting the steering column; and
sliding the steering column relative to the collar along the longitudinal axis.

18. The method of claim 15 further comprising the step of:
supporting at least a portion of a weight of the support bracket with a mounting bracket fixed to the vehicle.

19. The method of claim 15 further comprising the step of:
engaging the support bracket and mounting bracket together with first and second arcuate slots centered on the first end.

20. A steering column assembly for supporting a steering wheel in a vehicle comprising:
a steering column having a first end and a longitudinal axis and being disposable in a vehicle for raking movement about said first end and collapsing movement along said longitudinal axis wherein said steering column includes a first steering column member defining said first end and a second steering column member disposed for telescoping movement relative to said first steering column member along said longitudinal axis and for said raking movement with said first steering column member, and wherein at least said second steering column member is moveable in collapsing movement along said longitudinal axis;
a collar engaged with said steering column to move with said steering column at least during said raking movement and being slidable relative to said steering column, wherein said collar aperture encircles said second steering column member and is slidable relative to said second steering column member during said telescoping movement, and wherein said collar further comprises at least one connecting aperture spaced from said collar aperture;
a support bracket for supporting at least one gage of the vehicle and releasibly engaged with said collar such that said support bracket separates from said collar in response to said collapsing movement, wherein said support bracket releases from said collar in response to said collapsing movement, wherein said support bracket includes first and second arcuate slots radially centered on said first end, and wherein said support bracket further comprises at least one connecting slot aligned with said at least one connecting aperture of said collar;
at least one bolt extending through said at least one connecting aperture of said collar and said at least one slot of said support bracket;
a mounting bracket operable to be fixedly mounted to the vehicle wherein said support bracket is slidably engaged with said mounting bracket, wherein said mounting bracket includes first and second apertures and at least one guide aperture;
a pin extending through said first and second apertures of said mounting bracket and said first and second slots of said support bracket to guide movement of said support bracket during said raking movement of said steering column;
a rake bracket slidably engaged with said collar and having third and fourth arcuate slots centered on said first end for guiding movement of said collar during said raking movement of said steering column; and
at least one elongate member fixedly engaged with said rake bracket and slidably received in said at least one guide aperture of said mounting bracket for guiding movement of said rake bracket relative to said mounting bracket during said collapsing movement.
